(19) United States
(12) Patent Application Publication
(10) Pub. No.: US 2008/0318517 A1
(43) Pub. Date: Dec. 25, 2008

(54) UNIVERSAL ELECTRONIC DEVICE WITH HANDS-FREE MODULE AND/OR WITH GPS NAVIGATION SYSTEM AND BLUETOOTH MODULE, ESPECIALLY FOR AUTOMOBILE VEHICLES

(75) Inventor: Henryk Bury, Mielec (PL)

Correspondence Address: MATTHIAS SCHOLL, 14781 MEMORIAL DRIVE, SUITE 1319, HOUSTON, TX, 77079, US

(73) Assignee: BURY SP Z O.O., Mielec (PL)

(21) Appl. No.: 12/131,820

(22) Filed: Jun. 2, 2008

(30) Foreign Application Priority Data
Jun. 19, 2007 (EP) 07460013

(51) Int. Cl. H04H 20/74

(52) U.S. Cl. 455/3.02

(57) ABSTRACT

A universal electronic device with a hands-free module and/or a GPS navigation system and a Bluetooth module, especially for automobile vehicles with a hands-free module, a GPS navigation system and a Bluetooth module; the device provided with a casing (2) comprising a base (4) and a tiltable part (6), connected to the base by means of a hinge (5, 5a) with a release button (18), the base (4) including a speaker (9) of the hands-free module and a battery (10), as an independent power source, and the said tiltable part (6) of the casing (2) provided with an LCD display (7) and a microphone (17) of the hands-free module.

### CROSS-REFERENCE TO RELATED APPLICATIONS

This application claims priority to the European Patent Application No. EP07460013 filed Jun. 19, 2007, the contents of which are incorporated herein by reference.

### BACKGROUND OF THE INVENTION

1. Field of the Invention

This invention relates to a universal electronic device with a hands-free module and/or a GPS navigation system and a Bluetooth module, especially for automobile vehicles. The device is provided with a casing, which encloses the known hands-free module and the known GPS navigation system connected to the Bluetooth module.

2. Description of the Related Art

U.S. Pat. No. 5,308,247 discloses an electronic device and a rear view mirror fixed directly to the windshield with an adhesive. Similar solution is known from the German document DE 10 211 444 A1, where various electronic modules are fixed directly to the windshield with an adhesive. In order to strengthen the mounts an additional plastic handle, reinforced with glass fiber, is provided.

US Pat. Appl. Publ. No. US 2003/0068986 A1 describes a mobile phone car kit having a body with a slot to receive the mobile phone, a first holder to secure a lower part of the mobile phone, a second holder to elastically secure an upper part of the mobile phone to lock or release the upper part of the mobile device, a lock/release element movable between a locking position and a releasing position, an ejector to lift the mobile phone to a given distance when the lock/release is moved to the releasing position, and a mounting fixture including position adjusting units to adjust the angle and the height of the main body, and fixing units to fix the position of the adjusting unit in the vehicle. Since the apparatus has the lock/release and the ejector to automatically lock and release the mobile device and the mounting fixture to adjust the position of the main body, it is possible to lock and release the mobile phone and to set up the apparatus and the mobile phone in the vicinity of the window of the vehicle to facilitate GPS satellite transmission.

PCT Intl. Appl. Publ. No. WO 2005/029825 A1 discloses a hands-free mobile phone car kit provided with a wireless Bluetooth connection to the headphones and equipped with a passive communication module with a speaker and a microphone, or connected to an amplifier located in the casing, on the external surface of which there is provided a slot, into which the headphones having an electric connection to the communication unit can be inserted. The casing has also a connection with a plug for a 12V-socket, e.g., a lighter socket. The headphone set, equipped with a digital signal processor which comprises a wireless Bluetooth module with a background noise reduction system, is connected to the communication module so that it can adjust to the voltage of the communication module. Thanks to a switching circuit, it is possible to adapt the headphones' digital signal processor and the control buttons to operate with the speaker and the microphone of the communication module. In this way a simple hands-free car kit is made, consisting of a few simple components. All the headphone modules and components can operate with the speaker and the microphone of the communication module. All similar electric devices for mechanical vehicles are specialized devices such as mobile phones, Bluetooth modules of hands-free kits, etc.

### SUMMARY OF THE INVENTION

In one aspect the invention provides a universal electronic device, which comprises various electronic modules of different purposes, especially a hands-free module, a Bluetooth module and/or a GPS navigation device.

In one embodiment of the invention provided is a device that has a compact design, is portable, mountable to the windshield of a mechanical vehicle and suitable for use outside of the vehicle (a portable device).

In another embodiment of the invention provided is a universal electronic device with a hands-free module and/or a GPS navigation system and a Bluetooth module, especially for automobile vehicles, which comprises a casing comprising a base and a tiltable part, the tiltable part being connected to the base by means of a hinge with a release button, the base including a speaker of the hands-free module and a battery, as an independent power source, and the tiltable part provided with an LCD display and a microphone of the hands-free module.

In a class of this embodiment, the LCD display built in the tiltable part of the casing is preferably both a GPS display and a display for displaying commands executed by the device. This is a touch-pad display wherein the functions of the device can be entered by touch.

In a class of this embodiment, the LCD display is disposed on the external or internal, or both surfaces of the tiltable part of the casing.

In a class of this embodiment, on its external surface, the tiltable part of the casing is preferably provided with buttons, which activate and deactivate the functions executed by the device.

In a class of this embodiment, the base of the casing is preferably a resonant chamber for the speaker of the hands-free module.

In a class of this embodiment, on its external surface the base of the casing is preferably provided with a solar charger to charge the battery.

In a class of this embodiment, the device is preferably provided with a holder, fixed permanently to the windshield of a vehicle, and side buttons with protrusions engaging with the slots in the base of the casing.

In a class of this embodiment, the device is preferably provided with a connecting element, which engages with the slot in the holder.

When compared to other devices of such type, known in the state-of-the-art, the device according to the invention demonstrates not only its multi-functionality but also other benefits, namely, it is portable, easy to mount into the holder fixed to the windshield of a vehicle, easy to release from the said holder and to be put on the dashboard or outside the vehicle, e.g., on a desk.

In a class of this embodiment, the device can be connected to a PC. Moreover, the device is preferably provided with its own power source, independent from external power sources. This eliminates the need to provide electric cables to the device.

### BRIEF DESCRIPTION OF THE DRAWINGS

The universal electronic device with a hands-free module and/or a GPS navigation system and a Bluetooth module, especially for automobile vehicles, according to the invention, is depicted in the figures, wherein:

FIG. 1 shows the holder fixed to the windshield of the vehicle with the universal electronic device mounted to it in a closed position according to one embodiment of the invention;

FIG. 2 shows the device released from the holder in a half-open position according to one embodiment of the invention;

FIG. 3 shows the universal electronic device provided with control buttons according to another embodiment of the invention;

FIG. 4 shows the universal electronic device provided with a LCD display according to the embodiment of the invention shown in FIG. 3;

FIG. 5 shows the universal electronic device in a half-open position with the speaker of the hands-free module made visible according to another embodiment of the invention;

FIG. 6 shows the device mounted to the holder in an open position according to the embodiment of the invention shown in FIG. 5;

FIG. 7 shows the device in a closed position in a back view according to the embodiment of the invention shown in FIG. 6;

FIG. 8 shows the device with the holder with the electric connection to connect it to the electronic system of the vehicle according to another embodiment of the invention;

FIG. 9 shows the device with the hinge and the button according to another embodiment of the invention; and

FIG. 10 shows the device in a half-open position according to the embodiment of the invention shown FIG. 9.

### DETAILED DESCRIPTION OF THE INVENTION

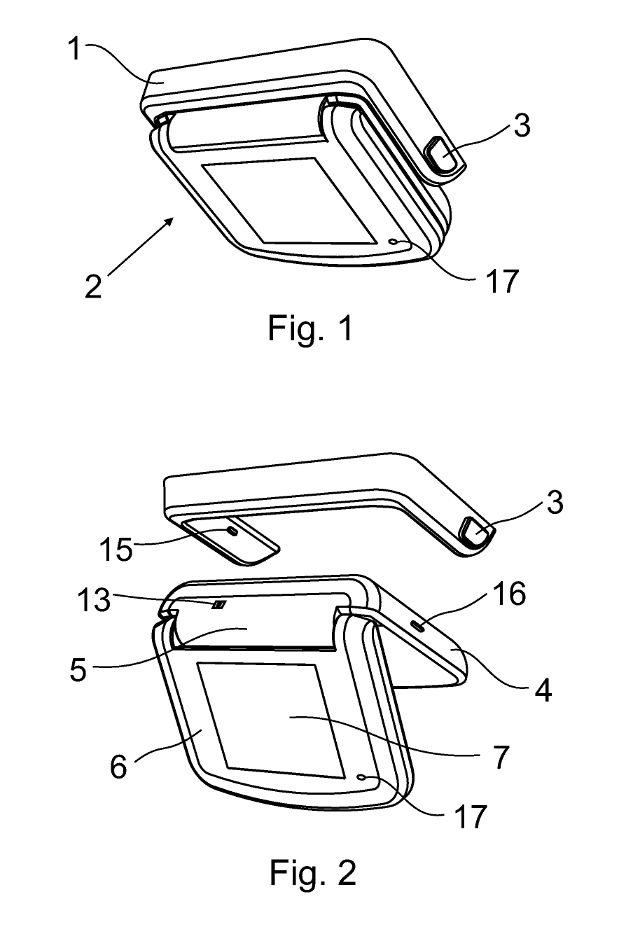

The universal electronic device, according to the invention, as shown in FIG. 1 and 2 comprises a holder 1, fixable permanently to the windshield of a vehicle, and a casing 2 mounted detachably to the holder 1. The holder is provided with side buttons 3, which are used to release the device and remove it from the holder. The casing 2 is bipartite and consists of the base 4 and the tiltable part 6 connected to the base with an articulated joint by means of a hinge 5.

Inside both parts 4 and 6 of the casing 2 disposed are the following electronic modules: a known hands-free module, a Bluetooth module and/or a known GPS navigation system. All of the modules are coupled with each other. An LCD display 7 is located on the external or internal surface of the tiltable part 6 of the casing 2.

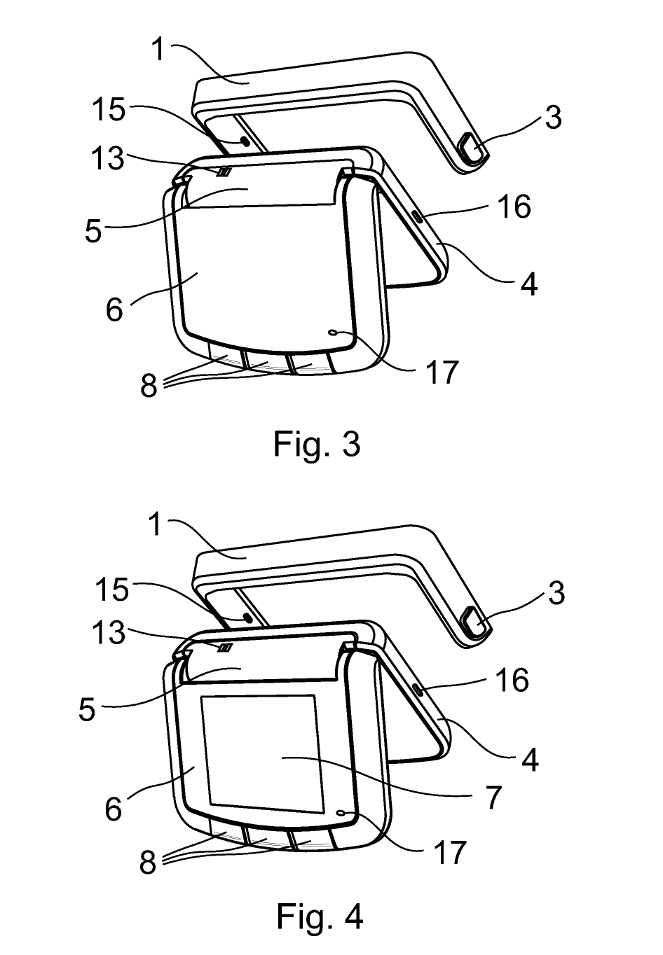

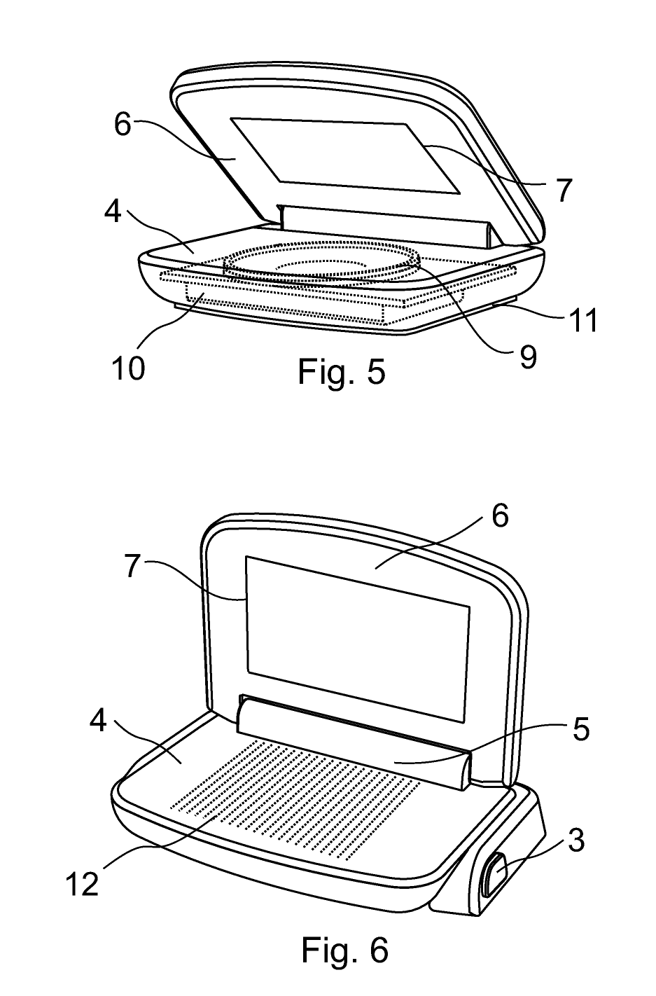

In the optional version of the device, as depicted in FIGS. 3 and 4, there are control buttons 8 on the external surface of the tiltable part 6 to control both electronic systems of the device. In the embodiment as depicted in FIGS. 1 and 2, the control is performed by touching the LCD display 7. In the embodiment shown in FIG. 5, the speaker 9 of the hands-free module is depicted in the base 4 of the casing 2 and the battery 10 is disposed beneath the speaker to provide power supply for the entire device. A solar charger 11 is conveniently located under the battery 10 to enable charging the device with solar energy.

The LCD display is located on the external or internal surface of the tilting part 6 and is used both to show the GPS map and to control the operation of the device. In this mode, appropriate control buttons are depicted on the display. Pressing a button activates a corresponding function of the device. A GPS antenna may be located inside the holder 1 or be attached to it by means of a suitable socket. Moreover, the device itself may be equipped with a GPS antenna located within the casing 2.

On the internal surface of the base 4 of the casing 2, as depicted in FIG. 6 disposed is shield 12 of the speaker 9 and the LCD display 7 is located on the internal surface of the tiltable part 6 of the casing 2.

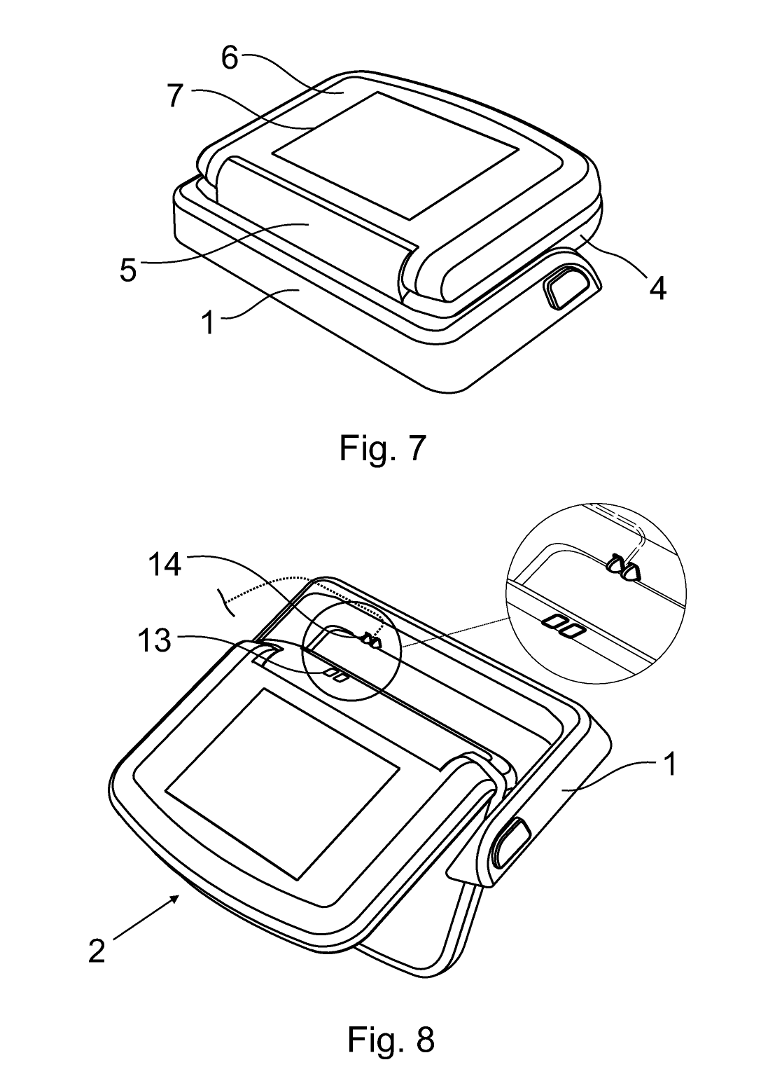

In the embodiment shown in FIG. 7, the LCD display 7 is located on the external surface of the tiltable part 6 of the casing 2.

An exemplary embodiment of the device shown in FIG. 8 is additionally provided with the connecting elements 13 engaging with the socket 14 located on the internal surface of the holder 1. In an enlarged view of the device, the connecting element 13 of the device is shown in the disconnected position.

The holder 1 of the device, preferably fixed directly to the windshield, is provided with side spring-loaded buttons 3, which control the protrusions 15 engaging with the corresponding slots 16 in the base 4 of the casing 2. Mounting the device, according to the invention within a vehicle is executed by pressing the base 4 of the casing 2 into the holder 1.

Individual electronic modules of the device are automatically activated when lifting the tiltable part 6 of the casing 2. In an alternative solution, these buttons can be activated one by one using the control buttons 8 or the relevant buttons showed on the LCD display 7.

The battery 10 of the device may be charged directly by the external vehicle system through the connecting elements 13, 14 or directly by means of a solar charger 11 built into the device.

The device can operate properly both locked in the holder 1, and removed from the holder 1 and placed on the dashboard of the vehicle, or even removed from the vehicle and placed elsewhere, e.g., on a desk. In any position, the device can communicate with a PC by means of a Bluetooth module

The device is also equipped with the microphone 17 connected to the hands-free module.

Preferably, the base 4 of the casing 2 is a resonant chamber for the speaker 9, thus improving its effectiveness.

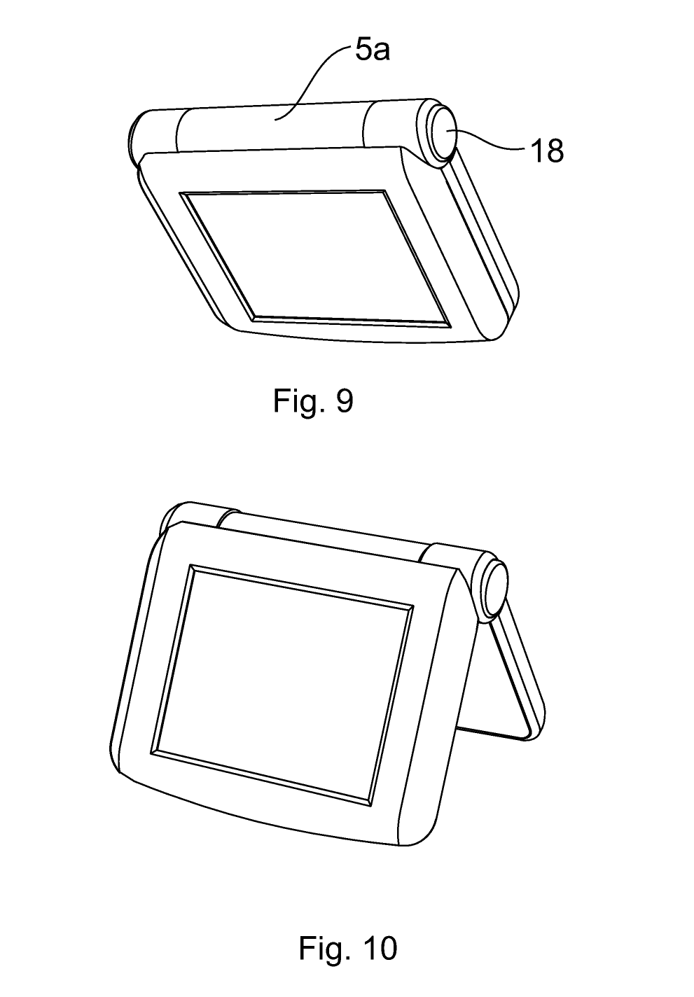

In another embodiment, shown in FIGS. 9 and 10, the base 4 and the tiltable part 6 are connected with a sleeve-type hinge 5a, in which there is the release button 18 engaged with a spring (not depicted in the drawing). Pressing the release button 18 facilitates lifting and changing the position of the tiltable part 6 in relation to the base 4. Leaving the buttons undepressed blocks the position of both parts of the casing.

Thanks to a compact design and own source of the power, the device is portable and may be used as a universal multimedia device, e.g., a hands-free kit for conferences or for sightseeing applications.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

1. A universal electronic device with a hands-free module and/or a GPS navigation system and a Bluetooth module comprising a casing enclosing a hands-free module, a GPS navigation system and a Bluetooth module, the casing (2) comprising a base (4) and a tiltable part (6), connected to the base by means of a hinge (5,5a) with a release button (18), said base (4) comprising a speaker (9) of the hands-free module and a battery (10), as an independent power source, and said tiltable part (6) of the casing (2) comprising an LCD display (7) and a microphone (17) of the hands-free module.

2. The device of claim 1, wherein the LCD display (7), built into the tiltable part (6) of the casing (2) has the function of both a GPS display and a display showing commands executed by the device.

3. The device of claim 2, wherein the LCD display (7) is provided with a touch-pad display to enable it to initiate functions of the device by touch.

4. The device of claim 2, wherein the LCD display (7) is disposed on an external surface or an internal surface, or on both surfaces of the tiltable part (6) of the casing (2).

5. The device according of claim 1, wherein the tiltable part (6) of the casing (2), on its external surface, is provided with buttons (8), which activate and deactivate functions executed by the device.

6. The device of claim 1, wherein the base (4) of the casing (2) is a resonant chamber for the speaker (9) of the hands-free module.

7. The device of claim 1, wherein the base (4) of the casing (2), on its external surface, is provided with a solar charger (11) to charge the battery.

8. The device of claim 1, further comprising a holder (1), permanently fixable to a windshield of a vehicle, and side buttons (3) with protrusions (15), engaging with the slots (16) in the base (4) of the casing (2).

9. The device of claim 1, further comprising a connecting element (13), said element engaging with the slot (14) in the holder (1).

10. A universal electronic device with a hands-free module and/or a GPS navigation system and a Bluetooth module comprising a casing enclosing a hands-free module with a microphone and a speaker, a GPS navigation system, a Bluetooth module, an LCD display, and a battery, the casing (2) being bipartite and comprising a base (4) and a tiltable part (6), connected to the base by means of a hinge (5,5a) with a release button (18), said base (4) comprising said speaker (9) of the hands-free module and said battery (10), as an independent power source, and said tiltable part (6) of the casing (2) comprising said LCD display (7) and said microphone (17) of the hands-free module, wherein said base (4) is a resonant chamber for said speaker (9) of the hands-free module.

11. The device of claim 10, wherein the LCD display (7), built into the tiltable part (6) of the casing (2) has the function of both a GPS display and a display showing commands executed by the device.

12. The device of claim 11, wherein the LCD display (7) is provided with a touch-pad display to enable it to initiate functions of the device by touch.

13. The device of claim 11, wherein the LCD display (7) is disposed on an external surface or an internal surface, or on both surfaces of the tiltable part (6) of the casing (2).

14. The device according of claim 10, wherein the tiltable part (6) of the casing (2), on its external surface, is provided with buttons (8), which activate and deactivate functions executed by the device.

15. The device of claim 10, wherein the base (4) of the casing (2), on its external surface, is provided with a solar charger (11) to charge the battery.

16. The device of claim 10, further comprising a holder (1), permanently fixable to a windshield of a vehicle, and side buttons (3) with protrusions (15), engaging with the slots (16) in the base (4) of the casing (2).

17. The device of claim 10, further comprising an electrical connecting element (13), said element engaging with electrical connecting elements (14) of the holder (1).
